(19) United States
(12) Patent Application Publication
(10) Pub. No.: US 2006/0206720 A1
(43) Pub. Date: Sep. 14, 2006

(54) Method, program and system for limiting I/O access of client

(76) Inventors: Hideki Harada, Yamato-Shi (JP); Takeshi Ohmori, Yokohama (JP); Yukinobu Moriya, Tokyo (JP); Taizoh Ueda, Yokohama-Shi (JP); Kunio Okuda, Sagamihara-Shi (JP)

Correspondence Address: DILLION & YUDELL LLP, 8911 N. CAPITAL OF TEXAS HWY, SUITE 2110, AUSTIN, TX, 78759, US

(21) Appl. No.: 11/369,558

(22) Filed: Mar. 7, 2006

(30) Foreign Application Priority Data
Mar. 8, 2005 (JP) 2005-063439

(51) Int. Cl. H04L 9/00

(52) U.S. Cl. 713/182

(57) ABSTRACT

A method of limiting I/O access of a client to prevent data in a client connected to the system from being leaked and stolen, the method further canceling the limitation under a predetermined condition even if the client can not communicate with a server is provided. The method comprising the steps of locking I/O access of the client, determining whether the client is connectable to the server via a network, unlocking I/O access of the client in response to a determination of the client being connectable, by authenticating the client by the server, and unlocking I/O access of the client in response to the client not being connectable, by connecting a portable authentication device to the client to authenticate the client by the portable authentication device.

### PRIORITY CLAIM

This application claims priority of Japanese Patent Application No.: 2005-063439, filed on Mar. 8, 2005, and entitled, “Method, Program and System for Limiting I/O Access of Client.”

### BACKGROUND OF THE INVENTION

1. Technical Field

The present invention relates to a method of limiting I/O access of a client, particularly to a method, program and system for limiting I/O access of a client computer connected to a communication network.

2. Description of Related Art

In recent years, there has been a growing interest in protecting personal information. In information processing systems operated in companies, there is a problem how to protect documents or the like describing personal information so that the personal information recorded in client computers used in the information processing systems is not be leaked, stolen or abused by third parties.

A method of authenticating a client used in an information processing system by a server to permit viewing or printing documents within the range of authentication is known (e.g., see Japanese Published Unexamined Patent Application No. 2004-280227).

However, the method described in PUPA No. 2004-280227 may not necessarily be sufficient for protecting personal information. That is, in the method described in PUPA No. 2004-280227, usage of a client is limited only for viewing or printing documents. Therefore, all of client I/O accesses (input/output including devices used at the client) cannot be controlled. Further, since the method described in PUPA No. 2004-280227 assumes that a user can connect to the server, limitation on the usage of the documents cannot be set or canceled if the user cannot connect to the server.

### SUMMARY OF THE INVENTION

An object of the present invention is to provide a method, program and system for limiting client I/O access to prevent data in a client connected to the system from being leaked and stolen, and further canceling the limitation under a predetermined condition even if the client can not communicate with the server.

According to a first embodiment of the present invention, there is provided a method of limiting I/O access of a client connected to a server via a network, a program for causing a computer to perform the method, and a system for implement the method, the method comprising the steps of: locking I/O access of the client; determining whether the client is connectable to the server via the network; unlocking I/O access of the client in response to a determination of the client being connectable in the connection determination step, by authenticating the client by the server; and unlocking I/O access of the client in response to a determination of the client not being connectable in the connection determination step, by connecting a portable authentication device to the client to authenticate the client by the portable authentication device.

According to a second embodiment of the present invention, there is provided a method of limiting I/O access of the client, a program for causing a computer to perform the method, and a system for implementing the method, wherein in addition to the first embodiment, in the first unlocking step, the client is authenticated by referencing a policy recorded in the client.

According to a third embodiment of the present invention, there is provided a method of limiting I/O access of the client, a program for causing a computer to perform the method, and a system for implementing the method, the method comprising a step of recording an I/O access history in the portable authentication device in addition to the first embodiment.

The foregoing summary of the invention is not intended to enumerate all features required for the present invention, but a subcombination of these feature groups may also be the present invention.

The above, as well as additional purposes, features, and advantages of the present invention will become apparent in the following detailed written description.

### BRIEF DESCRIPTION OF THE DRAWINGS

The novel features believed characteristic of the invention are set forth in the appended claims. The invention itself, however, as well as a preferred mode of use, further purposes and advantages thereof, will best be understood by reference to the following detailed description of an illustrative embodiment when read in conjunction with the accompanying drawings, where:

FIG. 1 shows a system configuration of a client control system 1;

FIG. 2 shows a functional block diagram of a control server 100;

FIG. 3 shows a functional block diagram of a client 300;

FIG. 4 shows a functional block diagram of a portable authentication device 200;

FIG. 5 shows a workflow of the client 300 in a client control system 1;

FIG. 6 shows an exemplary screen display prompting a user to connect a portable authentication device 200;

FIG. 7 shows an example of I/O access history data; and

FIG. 8 shows an example of hardware configurations for the control server 100 or the client 300.

### DETAILED DESCRIPTION OF THE PRESENT INVENTION

According to the present invention, a method, program and system can be provided which allows to prevent data leakage and stealing by limiting I/O access on a client, and which allows authentication of I/O access by authenticating I/O access at a server or at a portable authentication device when the limitation of I/O access is canceled, even if the user can not connect to the server.

With reference to the drawings, preferred embodiments of the present invention will be described below.

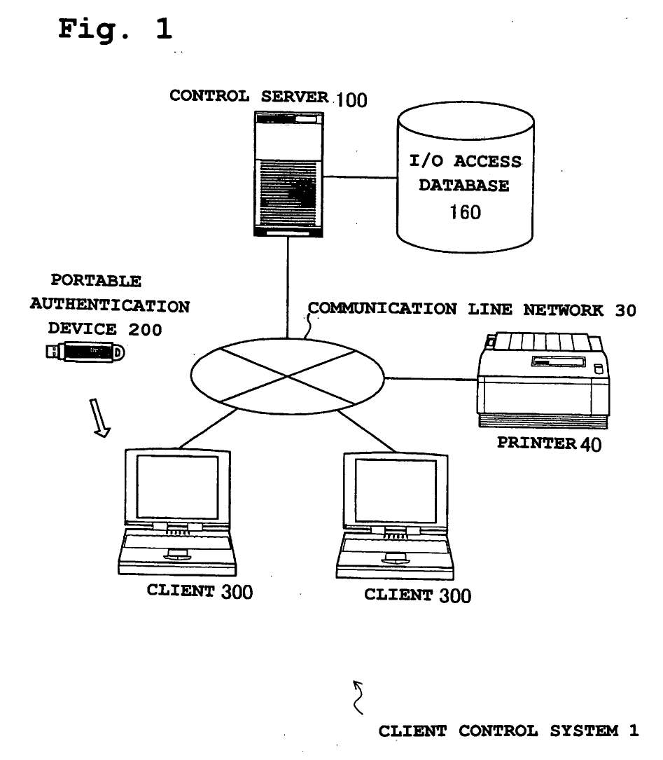

FIG. 1 is an example showing a configuration of a client control system 1. The client control system 1 is constituted by connecting a control server 100, a client 300 and a printer 40 via a communication line network 30. The communication line network 30 may be either a LAN, a public circuit, the Internet, a dedicated line or a network being comprised of a combination thereof.

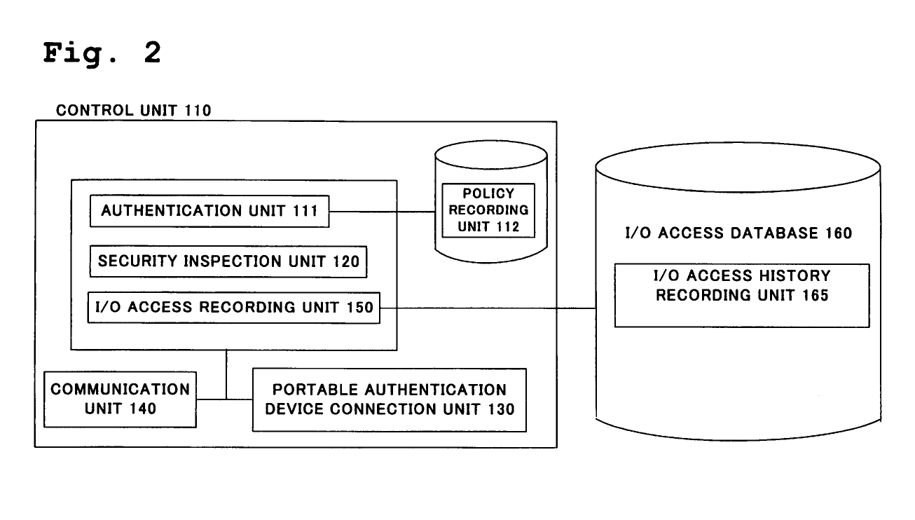

The control server 100 is a server for controlling I/O access of the client 300. The control server is comprised of a communication unit 140 for connecting to the communication line network 30 to make communication, an I/O access database 160 for recording information for the I/O access, an I/O access history recording unit 165 and a portable authentication device connection unit 130 for connecting to a portable authentication device 200 (see FIG. 2).

I/O access of the client 300 includes access for all input/output of the client 300. For example, I/O access may be viewing, editing, renaming, deleting or copying a document (file), accessing, renaming or deleting a folder, or may be printing by a particular printer 40, or may be copying a part of the document (using clipboard). Further, I/O access may be using (including recording and reading) a device such as a USB port, keyboard, network driver, Compact Disk (CD), CD-R, Digital Versatile Disk (DVD), Magneto-Optical (MO) or flexible disk.

A control unit 110 may be a central processing unit for controlling information for the control server 100. The control unit 110 is provided with an authentication unit 111 for authenticating the client 300, a security inspection unit 120 for performing security inspection and an I/O access recording unit 150 for recording I/O access of the client 300.

The authentication unit 111 references a policy recorded in a policy recording unit 112 to authenticate I/O access of the client 300. That is, the authentication unit 111 reads an identification number (e.g., serial number, MAC (Media Access Control) address, etc.) or account information for the client 300, and based on this, verifies that it is permitted or limited as I/O access based on the policy recorded in the policy recording unit 112.

The policy may be comprised of rules consisting of an identification number of the client 300 for which access is controlled, and the content of the controlled I/O access of the client 300. The policy may also be a group policy which is a rule applied to a plurality of clients 300. That is, the authentication unit 111 may also read the fact that the client 300 belongs to a predetermined group using the identification number or the account information for the client, and apply a group policy for each organization, section or the like based on the information.

When the authentication unit 111 authenticates the client, the security inspection unit 120 may also inspect the security of the client 300 and subsequently the client 300 may be authenticated.

For each terminal of the client 300, the I/O access recording unit 150 records the information for I/O access in an I/O access history recording portion 165 within the I/O access database 160. The information for I/O access refers to a history of I/O access used by the client 300 (e.g., access to a predetermined document or a folder and predetermined printing). The I/O access history is recorded in the I/O access history recording portion 165. The I/O access database 160 manages the I/O access history as data for each terminal of the client.

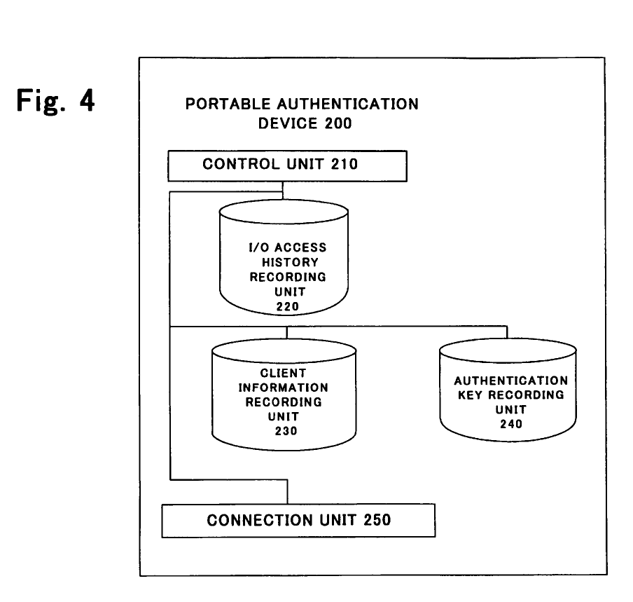

The portable authentication device connection unit 130 is connected to a portable authentication device 200 to input/output information from/to the portable authentication device 200. This will be described below with reference to FIG. 4.

The client 300 is a terminal such as a computer for which access is limited. As described above, the I/O access of the client 300 includes access for all input/output of the client 300 and includes those that relates to usage (recording, reading, printing, etc.) of an input/output device available at the client 300 along with input from a keyboard or the like of the client 300, viewing and editing a document (a file recorded in the client 300). The client 300 may be a computer, personal digital assistance, mobile phone or the like.

The client 300 is comprised of a control unit 310 for controlling and operating information, a communication unit 320 for connecting to the communication line network 30 to communicate with it, an I/O unit 330 for processing input/output of the client 300 and a portable authentication device connecting unit 340 for connecting the portable authentication device 200.

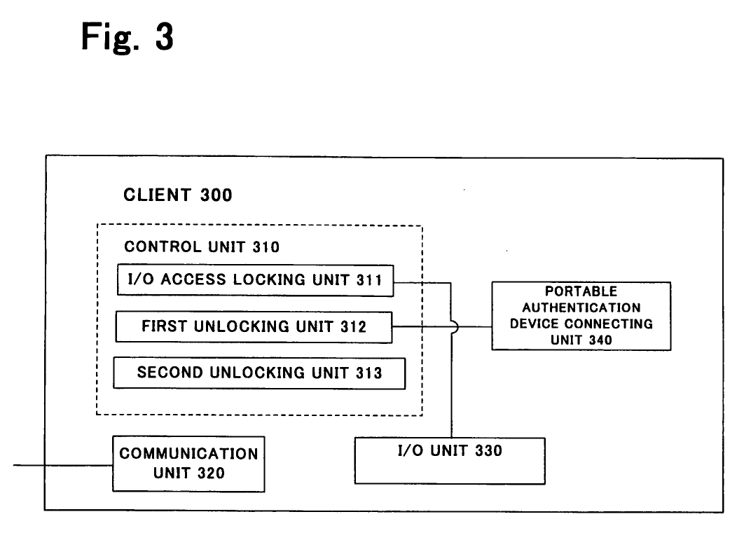

The control unit 310 may be a central processing unit for controlling information for the client 300. The control unit 310 includes an I/O access locking unit 311 for locking I/O access of client 300, a first unlocking unit 312 and a second unlocking unit 313 for unlocking the locked I/O (see FIG. 3).

The I/O access locking unit 311 limits (locks) a predetermined I/O access of the client. Limiting the I/O access means the limiting the above-described usage of I/O access. For example, it may be rejecting input from a keyboard or the like of the client 300, prohibiting viewing a predetermined document, prohibiting editing or prohibiting access to a predetermined folder.

When the client can not connect to the control server 100 or the client 300 is not active such as at shutdown (and suspend), the I/O access locking unit 311 may limit access from a keyboard. The limitation on the I/O access by the I/O access locking unit 311 is canceled by the first unlocking unit 312 or the second unlocking unit 313.

The first unlocking unit 312 unlocks the locked I/O access of the client 300. The first unlocking unit 312 request authentication from the authentication unit 111 in the control server 100 via the communication unit 320. If authentication completes successfully, the first unlocking unit 312 unlocks the locked I/O access.

The second unlocking unit 313 unlocks the locked I/O access of the client 300. That is, the second unlocking unit 313 authenticates the I/O access using the portable authentication device 200 and unlocks the I/O access.

The I/O unit 330 controls hardware or software for processing input/output of the client 300. That is, the I/O unit 330 may be embodied in a driver or the like for hardware processing input/output of a keyboard, printer, network driver, CD, CD-R, DVD, MO, flexible disk, USB port or the like. The I/O unit 330 may also be embodied in software as an application program for editing (input) and displaying (output) a document for which input/output is provided, for accessing to a folder or the like.

The portable authentication device connecting unit 340 is connected to the portable authentication device 200 to input/output information from/to the portable authentication device 200.

The portable authentication device 200 is a device for performing second unlocking to the limitation on I/O access on the client 300. That is, the portable authentication device 200 is physically connected to the client 300 and unlocks the limitation on the I/O access using the connection to authenticate the I/O access of the client 300 (second unlocking). The portable authentication device 200 is comprised of a control unit 210 for controlling information recorded in the portable authentication device 200, a I/O access history recording unit 220 for recording I/O access history, a client information recording unit 230 for recording information for the connected client 300, an authentication recording unit 240 for recording a authenticated key, and a connecting unit 250 for connecting to the client 300 (see FIG. 4).

The portable authentication device 200 may be a portable device connectable to the client 300 or may be a USB key. The USB key is a device which comprises an interface to a USB (Universal Serial Bus) port and records a key (password, unlocking key) for authenticating I/O access of a connected computer.

When the portable authentication device 200 is connected to the client 300, the I/O access history recording unit 220 records I/O access history of the client 300. The I/O access history is a history for I/O access used by the client 300 (e.g., viewing a predetermined document, accessing a folder, a predetermined printing, etc.). When the portable authentication device 200 is connected to the control server 100, the I/O access history recorded in the I/O access history recording unit 220 is read by the I/O access recording unit 150 in the control server 100 and recorded in the I/O access database 160.

The I/O access history recording unit 220 may be provided in a region to which a user can not access from the client 300 (user inaccessible region). Than is, if the I/O access history recording unit 220 is easily accessible to a user using the client 300, The I/O access history may be falsely rewritten. Accordingly, the I/O access history recording unit 220 may be located in a place that is not easily accessible to a program used in a normal file system.

The client information recording unit 230 records information for the client 300 connected to the portable authentication device 200. That is, when the portable authentication device 200 is connected to the control server 100, the client information recording unit 230 records the identification information (serial number, MAC address, etc.) of the client 300 to be authenticated using the portable authentication device 200.

The authentication recording unit 240 records a key (password, decryption key) for authentication. When the client 300 is connected to the portable authentication device 200, authentication is made based on the information recorded in the authentication recording unit 240.

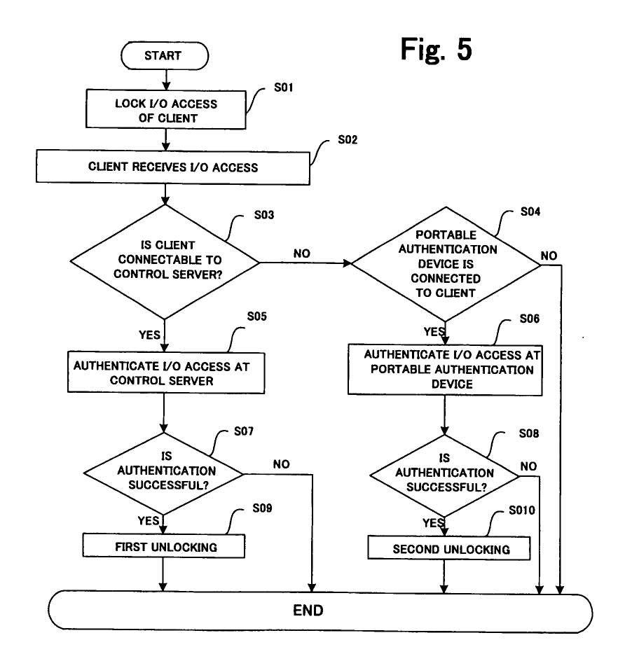

FIG. 5 shows a workflow of the client control system 1. Initially, the I/O access locking unit 311 locks I/O access of the client 300 (step S01). The timing when the I/O access of the client 300 is locked may be when the client 300 can not connect to the control server 100 or when the client 300 is not active such as at shutdown (and suspend).

Alternatively, when information for I/O access control (e.g., policy) recorded in the control server 100 is updated, the I/O access locking unit 311 can lock the I/O access. That is, an administrator of the system updates information at the control server 100 (e.g., policy) for controlling I/O access (document, folder, printer, etc.) to be locked at the client 300. In response to the update, the control server 100 may send I/O access information to be controlled to the client 300, and the client may lock the targeted I/O access based on the received information.

When a user attempts I/O access, the I/O unit 330 in the client 300 receives the I/O access (step S02). That is, for example, when the user performs input from the keyboard in the client 300, or when the user accesses to a particular document, or when the user performs printing using a predetermined printer 40 or the like, the client 300 determines that the I/O access is received.

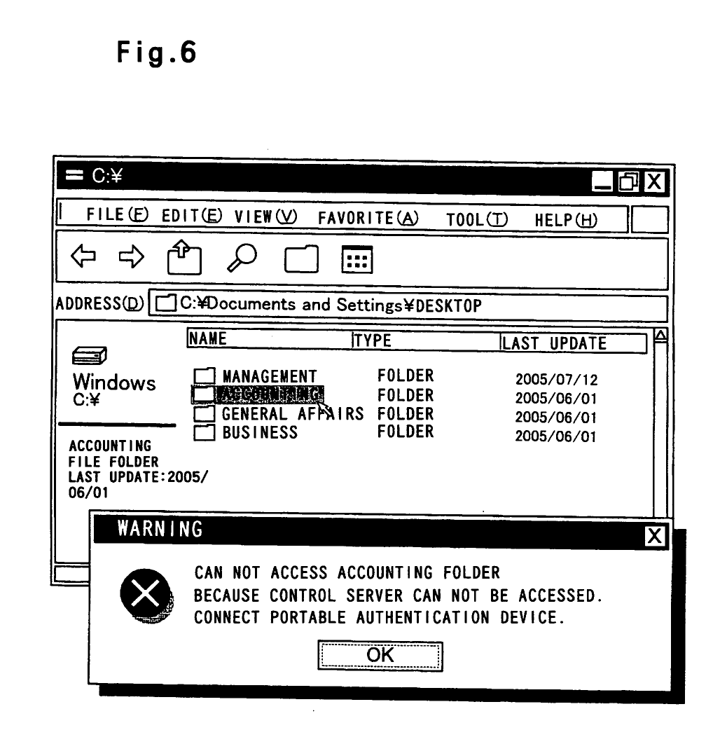

Next, the client 300 determines whether it can communicate with the control server 100 (step S03). If so, I/O access received at the control server 100 is authenticated (step S05). If not, it is determined whether the portable authentication device 200 is connected (step S04). Before the determination is made at step S04, a message as shown in FIG. 6 may also displayed to the client 300.

That is, in FIG. 6, there is shown an exemplary screen display in the case of attempting to access an accounting folder to view and edit a document or the like recorded in the client 300. This is a screen display in which the user is warned that authentication is not performed by the control server 100 but by the portable authentication device 200 because the client 300 can not communicate with the server 100.

If the client 300 can access to the control server 100, the I/O access received at step S02 is authenticated by the authentication unit 111 in the control server 100 (step S07). When the authentication unit 111 performs authentication, authentication may be based on the identification number of the client 300 which performs the I/O access. If the authentication unit 111 successfully completes authentication, the first unlocking unit 312 unlocks (first unlocking) the I/O access (step S09) and the I/O access is permitted. If authentication by the control server 100 fails, the process ends without unlocking.

On the other hand, if the client can not connect to the control server 100 and the portable authentication device 200 is connected to the client 300, authentication is performed by the connected portable authentication device 200 (step S06). If the portable authentication device 200 is not connected to the client 300, the process ends without unlocking the I/O access since authentication can not be performed. If authentication is completed successfully using the authentication key, unlocking (second unlocking) is performed by the portable authentication device 200 (step S10) and the I/O access of the client 300 is permitted. If the second unlocking unit 313 can not successfully complete authentication, the process ends without unlocking.

In addition to the authentication key in the portable authentication device 200, the second unlocking unit 313 in the portable authentication device 200 can also perform authentication by prompting a user operating the client 300 to input password. The authentication key also has validity period. That is, If authentication is performed within the validity performed, authentication using the authentication key is valid. Otherwise, authentication using the authentication key is disabled.

Modes of use of the portable authentication device 200 include the situation that the client 300 is a notebook computer and is carried to the outside where it is impossible to connect to the control server 100. In this case, locking of I/O access can not be unlocked since authentication can not be performed by the control server 100. Therefore, an administrator of the system hands the portable authentication device 200 to a user of the client 300. At the outside, user can authenticate the client 300 using the portable authentication device 200 to perform I/O access recorded in the client 300 (using a document, a device, etc.). At this time, an I/O access history performed at the client is recorded in the portable authentication device 200. Subsequently, the user of the client 300 returns the portable authentication device to the administrator of the system. The administrator of the system connects the returned portable authentication device 200 to the control server 100 to collect the I/O access history.

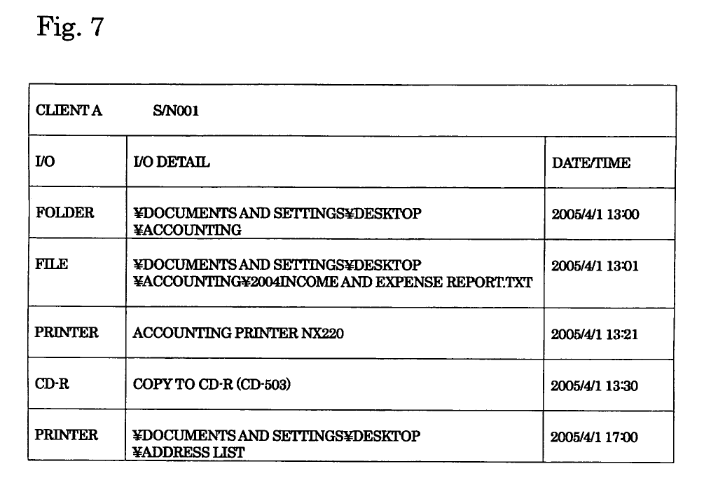

A table in FIG. 7 is data showing access history of the client A. The I/O access history data as shown in FIG. 7 is collected at the client 300 and sent to the control server 100 to record it in an I/O access history recording portion 165. If the client 300 can not communicate with the control server 100 and I/O access has been performed by performing authentication at the portable authentication device 200, this I/O access history data is recorded in the I/O access history recording unit 220 in the portable authentication device 200. If the portable authentication device 200 is connected to the control server 100, the I/O access recording unit 150 reads the I/O access history data recorded in the portable authentication device 200 to record it in the I/O access history recording portion 165. At this time, the I/O access history data includes an identification number for each client to indicate which client 300 is related to the I/O access history information.

The I/O access history data is comprised of a client name (client A), a serial number (S/N) of the client, a name of I/O for which access occurs, details of the I/O and date and time when the I/O access occurs. The I/O access history data includes information regarding which client has performed access, what I/O access the client has performed, and when the client has performed access. For example, in the I/O access history data in FIG. 7, the client name is client A and the serial number (identification number) is 001. This shows that I/O access has been performed to the described I/O at the described data and time. For each client 300, such I/O access history data is recorded in the I/O access history recording portion 165 in the control server 100. Accordingly, The control server 100 can record history information for I/O access of all clients 300 and the administrator using the system can obtain history information for unauthenticated I/O access.

As is apparent from the foregoing description, according to the inventive method, program and system for limiting I/O access of the client 300, limiting I/O access on the client 300 allows protection of personal information record in the client 300. When limitation on this I/O access is canceled, authentication is performed using the control server 100 or the portable authentication description 200 to unlock I/O access control only when authentication is successfully completed. Accordingly, even if the client 300 is not accessible to the control 100, a method, program and system can be provided allowing I/O access authentication. That is, the present invention assumes that the I/O access to be controlled for the client 300 is locked and I/O access is permitted only when authentication is successfully completed. Accordingly, it is possible to prevent data leaking and stealing resulting from I/O access by an unauthenticated user. Further, according to another embodiment, such I/O access history is recorded in the control server 100, thus I/O access history data can be provided for examining the cause of a questionable or unauthenticated access.

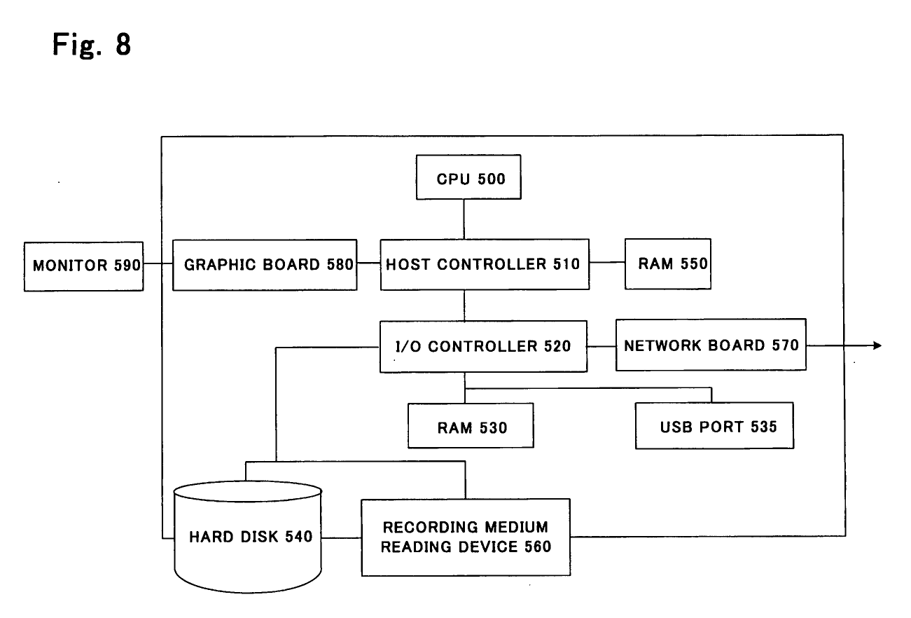

FIG. 8 shows an example of hardware configurations for the control server 100 and the client 300. CPU 500 reads a program for performing a method of controlling the client 300 via a host controller 510 and an I/O controller 520 from a hard disk 540 or a recording medium reading device 560, and records the read program in a RAM 550 to execute the program. By executing each step constituting the program, the CPU 500 in the control server 100 can also function as the authentication unit 111, the security inspection unit 120 and the I/O access recording unit 150. In the client 300, the CPU 500 can also function as the I/O access locking unit 311, the first unlocking unit 312 and the second unlocking unit 313 by reading the program (agent program). In executing the program, data recorded in the hard disk 540 or the recording medium reading device 560 can also be read. The CPU 500 displays the result of determining or operating information on a monitor 590 via the host controller 510. The CPU 500 obtains data from the control server 100 or the client 300 connected via a network board 570 and the I/O controller 520 to the communication network. The CPU 500 in the client 300 may display the exemplary screen display shown in FIG. 6 via a graphic board 580 on the monitor 590.

The method of limiting I/O access of the client 300 providing these embodiments can be implemented by a program for running in a computer or a server. The recording media for this program includes an optical recording medium, tape medium, solid-state memory, etc. Alternatively, using a hard disk, a RAM or the like connected to a dedicated communication network or the Internet as a recording medium, the program may be provided via the network.

It should be understood that at least some aspects of the present invention may alternatively be implemented in a computer-useable medium that contains a program product. Programs defining functions on the present invention can be delivered to a data storage system or a computer system via a variety of signal-bearing media, which include, without limitation, non-writable storage media (e.g., CD-ROM), writable storage media (e.g., hard disk drive, read/write CD ROM, optical media), system memory such as but not limited to Random Access Memory (RAM), and communication media, such as computer and telephone networks including Ethernet, the Internet, wireless networks, and like network systems. It should be understood, therefore, that such signal-bearing media when carrying or encoding computer readable instructions that direct method functions in the present invention, represent alternative embodiments of the present invention. Further, it is understood that the present invention may be implemented by a system having means in the form of hardware, software, or a combination of software and hardware as described herein or their equivalent.

While the present invention has been particularly shown and described with reference to a preferred embodiment, it will be understood by those skilled in the art that various changes in form and detail may be made therein without departing from the spirit and scope of the invention. Furthermore, as used in the specification and the appended claims, the term “computer” or “system” or “computer system” or “computing device” includes any data processing system including, but not limited to, personal computers, servers, workstations, network computers, main frame computers, routers, switches, Personal Digital Assistants (PDA's), telephones, and any other system capable of processing, transmitting, receiving, capturing and/or storing data.

1. A method of limiting Input/Output (I/O) access of a client connected to a server via a network, the method comprising the steps of:
locking I/O access of a client;
determining whether said client is connectable to a server via a network;
in response to a determination of said client being connectable in said determining step, unlocking I/O access of said client in a first unlocking step by authenticating said client by said server; and
in response to a determination of said client not being connectable in said determining step, unlocking I/O access of said client in a second unlocking step by connecting a portable authentication device to said client to authenticate said client by said portable authentication device.

2. The method of limiting I/O access of the client according to claim 1, wherein:
in said first unlocking step, said client is authenticated by referencing a policy recorded in said client.

3. The method of limiting I/O access of the client according to claim 2, wherein:
in said first unlocking step, said client is authenticated by said policy referencing a group policy.

4. The method of limiting I/O access of the client according to claim 1, wherein:
in said first locking step, in response to said client being in standby mode, determining that said client is not active, and in response to determining that said client is not active, locking I/O access of said client.

5. The method of limiting 1/O access of the client according to claim 1, wherein:
in said first unlocking step, in response to a security inspection for said client being passed, authenticating said client to unlock I/O access of said client.

6. The method of limiting I/O access of the client according to claim 1, wherein:
in said second unlocking step, authenticating said client by a serial number of said client recorded in said portable authentication device to unlock I/O access of said client.

7. The method of limiting I/O access of the client according to claim 1, wherein:
in said second unlocking step, authenticating said client by a password for an account installed at said client and recorded in said portable authentication device to unlock I/O access of said client.

8. The method of limiting I/O access of the client according to claim 1, further comprising a step of:
recording an I/O access history in said portable authentication device.

9. The method of limiting I/O access of the client according to claim 8, further comprising a step of:
sending the recorded I/O access history to said server after said recording step.

10. The method of limiting I/O access of the client according to claim 8, wherein:
the I/O access history recorded in said portable authentication device is a utilization history of a USB port, keyboard, printer, network driver, CD, CD-R, DVD, MO and flexible disk file or an access history of a folder of said client.

11. The method of limiting I/O access of the client according to claim 1, wherein:
in said first unlocking step, after I/O access of said client is unlocked, said client name, the unlocked I/O access and unlocked date and time are recorded in said server.

12. The method of limiting I/O access of the client according to claim 1, wherein:
said portable authentication device is a USB key.

13. A computer-usable medium embodying computer program code, the computer program code comprising computer executable instructions configured for:
locking I/O access of a client;
determining whether said client is connectable to a server via a network;
in response to a determination of said client being connectable in said determining step, unlocking I/O access of said client in a first unlocking step by authenticating said client by said server; and
in response to a determination of said client not being connectable in said determining step, unlocking I/O access of said client in a second unlocking step by connecting a portable authentication device to said client to authenticate said client by said portable authentication device.

14. The computer-usable medium of claim 13, wherein in said first unlocking step, said client is authenticated by referencing a policy recorded in said client.

15. A client control system for limiting I/O access of a client connected a server via a network, wherein:
said client comprises an I/O access locking unit for locking I/O access of said client, a communication unit for determining whether said client is connectable to said server via said network and accessing to said server in response to a determination of said client being connectable, and a first unlocking unit for unlocking I/O access of said client in response to a determination of said client not being connectable and in response to a determination of said portable authentication device being connected, by authenticating said client by said portable authentication device; and
said server comprises a second unlocking unit for unlocking I/O access of said client in response to the access from said client, by authenticating said client.

16. A client control system according to claim 15, wherein:
the I/O access history recorded in said portable authentication device is a utilization history of a USB port, printer, network driver, CD, CD-R, DVD, MO and flexible disk file or an access history of a folder of said client.

17. A client control system according to claim 15, wherein:
said portable authentication device is a USB key.
